(19) United States
(12) Patent Application Publication
(10) Pub. No.: US 2015/0197969 A1
(43) Pub. Date: Jul. 16, 2015

(54) DRAWER KNOB LATCH

(71) Applicant: Marine Town Inc., New Taipei City (TW)

(72) Inventor: Chin-Chung TUNG, New Taipei City (TW)

(21) Appl. No.: 14/152,718

(22) Filed: Jan. 10, 2014

(51) Int. Cl. E05C 1/16

(52) U.S. Cl. CPC E05C 1/16

(57) ABSTRACT

A drawer knob latch installed on a drawer capable of sliding inward or outward on a main body includes a casing with a hollow space therein and inserted on a front board of a drawer wherein one end thereof protruding inwardly from the front board is peripherally and radially provided with a latch hole, a latch slidingly disposed in the latch hole, a pivot axle slidingly moveably disposed in the space along a central axis of the casing and driven by a driving assembly in the space to move toward or away from the latch to reach either a locked position or a released position, and a drawer buckle connecting to the driving assembly and exposing on the outer side of the casing and the front board for driving the motion of the driving assembly and thus controlling the locking status of the latch.

### BACKGROUND OF THE INVENTION

1. Field of the Invention

The present invention relates to drawer latches, more particularly, to a drawer latch combining a locking member to a drawer.

2. Description of the Related Art

Normally, a drawer of cabinets and tables is installed with a drawer buckle for being held or gripped by users to open or close the drawer. However, to prevent drawers from being accidentally opened on the transportations such as ships or aircrafts, a drawer latch is needed to keep the drawers closed.

Known arts for latching a drawer, such as U.S. Pat. No. 7,340,928B2, provide a drawer lock installed on the front board of the drawer, which comprises a lock core inserted on the front board, wherein the lock core is provided with a block plate on one end adjacent to the front board. However, the lock core shall be inserted with a key for driving the block plate to rotate, thereby locking the drawer. Also, the drawer buckle and the drawer lock are disposed separately, so the installation and application thereof are more complex.

Regarding another patent, US2006/0082163A1, which applies a knob connected to a shaft, a key-hole-cam is disposed on the shaft for controlling a wedge to protrude or be withdrawn from the drawer, thereby locking or unlocking the drawer. Such method applies the knob as a drawer buckle and thus simplifies the installation. However, due to the lack of an efficient positioning means, shaking may possibly displace the wedge, thereby losing the locking effect.

Regarding still another patent, U.S. Pat. No. 6,575,503B1, although user only needs to turn the knob to move the pawl between a locked position and a released position, when the pawl is withdrawn to the released position, the drawer is not fixed by any force, whereby slight tilting or shaking can easily causes the drawer to slide open when applied on ships or aircrafts. Further, components for driving the pawl are relatively small-sized. When the user overly imposes a force upon or purposely damage the drawer, internal components are easily loosened and broken. Therefore, an improvement is needed.

### SUMMARY OF THE INVENTION

For improving the difficulties previously described of the known arts, the present invention provides a drawer knob latch, which not only possesses the effects of drawer buckle and lock device at the same time, but also is allowed to be steadily locked and prevented from loosened; furthermore, the locking/unlocking method is simple, time-saving and convenient for operation.

A drawer knob latch of the present invention which is installed on a drawer capable of sliding inwardly or outwardly on a main body comprises:

a casing, provided with a hollow space therein, and inserted on a front board of a drawer, wherein one end of casing protruding inwardly from the front board is peripherally and radially provided with a latch hole;

a latch, comprising a bevel end and an inner end which is slidingly disposed in the latch hole;

a pivot axle, slidingly moveably disposed in the space along a central axis of the casing, and driven by a driving assembly in the space, thus capable of moving toward or away from the latch, thereby moving between a locked position and a released position; and

a drawer buckle, connecting to the driving assembly and exposing on the outer side of the casing and the front board for being held or gripped to drive the motion of the driving assembly.

The first objective of the present invention is that the drawer buckle can be applied to directly drive the driving assembly to move rotationally or axially, thereby causing the pivot axle to move between a locked position and a released position. When the pivot axle is moved to the locked position, at least a part thereof is located between the casing and the inner end of the latch, whereby the latch is not allowed to be pushed down into the latch hole; when the pivot axle is moved to the released position, the pivot axle is away from the inner end of the latch, whereby the latch is allowed to freely slide in the latch hole, and thus being pushed down into the latch hole.

Second objective of the present invention is that the driving assembly comprises:

a hollow barrel, fixed in the space, and at least one flexible part disposed on a side wall of the hollow barrel, with a hook protruding from the inner side of the flexible part;

a tube body, rotatably disposed in the hollow barrel, with one end thereof provided with an axle hole for receiving an end of the pivot axle, and the other end connecting to the drawer buckle;

therein, at least one guiding notch for coupling the hook is concavely disposed on the peripheral surface of the tube body and thereby driving the tube body and the pivot axle to move together freely between the locked position and the released position along the outline of the guiding notch when the drawer buckle drives the tube body to move.

The third objective of the present invention is that the tube body is provided with a contact hole on the end connecting to the drawer buckle for the drawer buckle to be attached by at least one method selected from the group consisting of screwing, fixing, adhering, and welding. Therefore, the present invention can adapt current drawer buckles for being installed on cabinets or tables with different styles, thereby preventing normal usages or appearances from being negatively affected by different designs, thus increasing the added value of the present invention.

The fourth objective of the present invention is that a radial resilient member is provided between the casing and the inner end of the latch, whereby the bevel end of the latch is permanently exposing on the surface of the casing. When the pivot axle is moved to the released position, the latch is still able to provide slight fixing force, thereby preventing the drawer from accidentally sliding open due to slight tilting or shaking, especially on transportations such as ships or aircrafts. Further, the pivot axle is made of metal or alloy rod material, thus providing sufficient blocking strength for preventing the latch from being pushed down.

The fifth objective of the present invention is to provide an over-travel protection, whereby the maximum displacement of the device during operation is refrained for preventing the flexible part and the hook from detaching from the guiding notch or damaged due to force overly exerted by the user.

### BRIEF DESCRIPTION OF THE DRAWINGS

FIG. 1 is a perspective view of the drawer knob latch in accordance with the present invention.

FIG. 2 is an exploded view of the drawer knob latch in accordance with the present invention

FIG. 3 is a partial exploded view of the driving assembly of the present invention.

FIG. 4 is a schematic sectional view illustrating an embodiment of the present invention while the pivot axle is at the released position.

FIG. 5 is a cross-sectional view taken along the line 6-6 in FIG. 4.

FIG. 6 is a schematic view illustrating the drawer at an open status.

FIG. 7 is a schematic sectional view illustrating the embodiment of the present invention while the pivot axle is at the locked position.

FIG. 8 is a cross-sectional view taken along the line 8-8 in FIG. 7.

FIG. 9 is a schematic view illustrating the unlocking operation of the present invention.

FIG. 10 is another schematic view illustrating the unlocking operation of the present invention.

FIG. 11 is still another schematic view illustrating the unlocking operation of the present invention.

### DETAILED DESCRIPTION OF THE INVENTION

Other and further advantages and features of the present invention will be understood by reference to the description of the preferred embodiment in conjunction with the accompanying drawings where the components are illustrated based on a proportion for explanation but not subject to the actual component proportion.

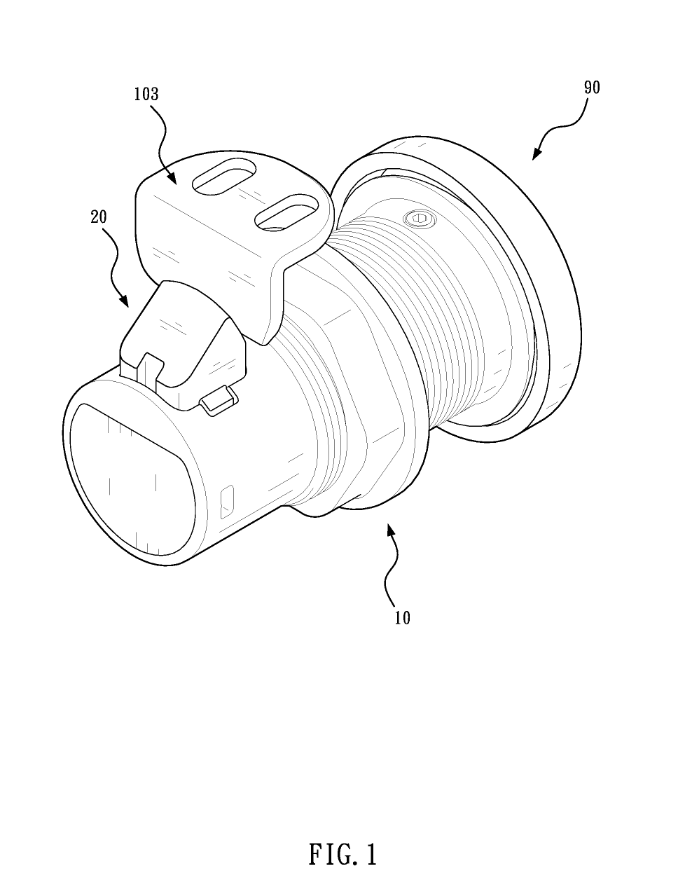

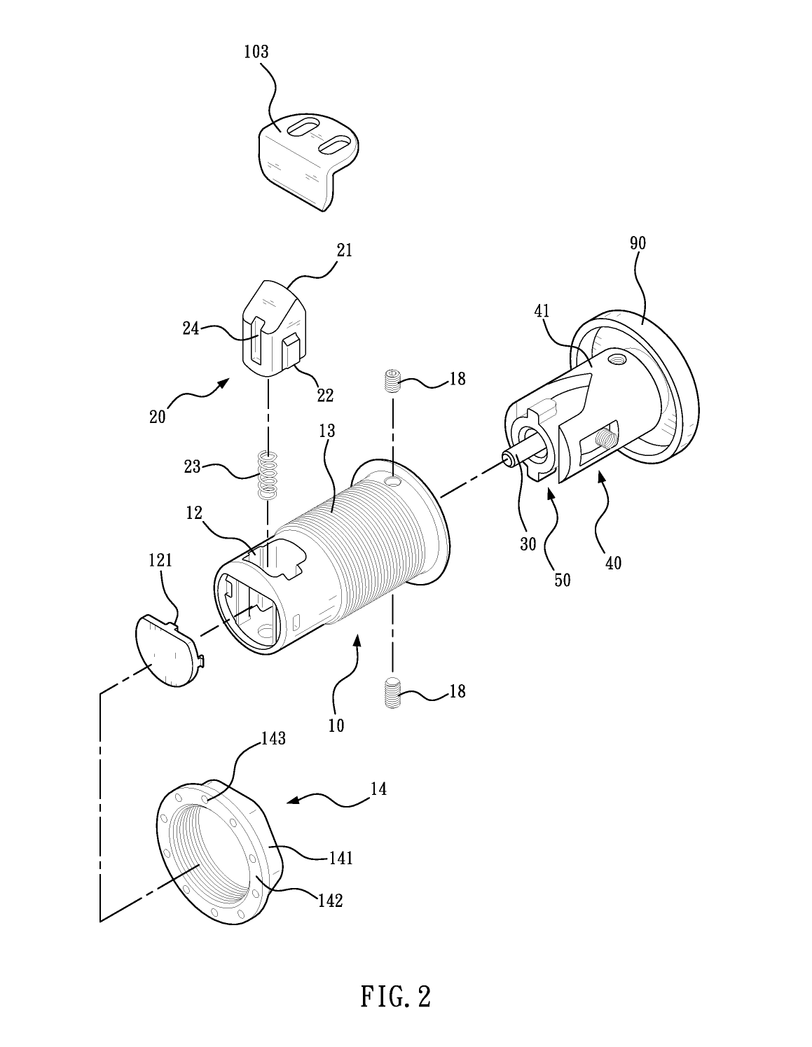

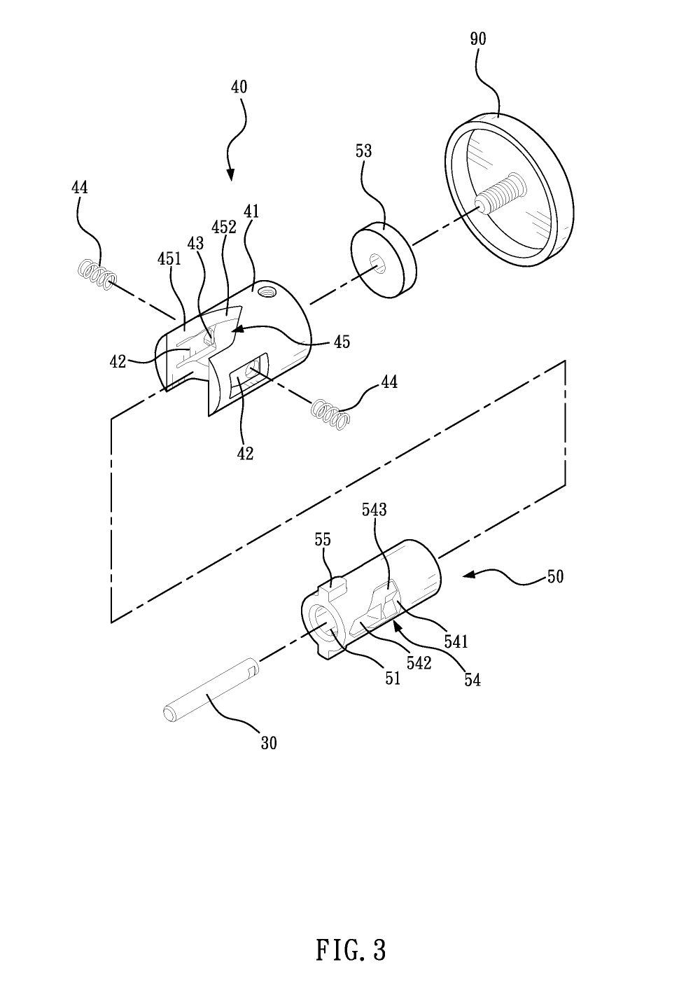

Referring to FIG. 1 to FIG. 5, a drawer knob latch of the present invention, which is installed on a drawer 101 capable of sliding inwardly or outwardly on a main body 100, comprises:

a casing 10, provided with a hollow space 11 therein, and inserted on a front board 102 of a drawer 101, wherein one end of the casing 10 protruding inwardly from the front board 102 is peripherally and radially provided with a latch hole 12, and a threaded section 13 is disposed on the peripheral surface of the casing 10 for a ring part 14 to be screwed on, with the ring part 14 provided with an angled part 141 and a protrusive edge 142, while the angled part 141 is allowed to be connected with tools such as wrenches for inserting and fixing the casing 10 on the front board 102, and the protrusive edge 142 is provided with plural convex points 143 for strengthening the fastening force between the ring part 14 and the front board 102;

a latch 20, comprising a bevel end 21 and an inner end 22 which is slidingly disposed in the latch hole 12, a radial resilient member 23 provided between the casing 10 and the inner end 22 of the latch 20 for permanently keeping the bevel end 21 of the latch 20 protruding and exposing on the surface of the casing 10, wherein a positioning groove 24 is concavely disposed on the latch 20, and a limiter 121 capable of sliding in the positioning groove 24 is convexly disposed in the latch hole 12 for limiting the sliding movement of the latch 20 in the latch hole 12;

a pivot axle 30, slidingly moveably disposed in the space 11 along a central axis of the casing 10, and driven by a driving assembly 40 in the space, thus capable of moving toward or away from the latch 20, thereby moving between a locked position and a released position, wherein when the pivot axle 30 is moved to the locked position, at least a part thereof is located between the casing 10 and the inner end 22 of the latch 20, whereby the latch is not allowed to be pushed down into the latch hole 12, and when the pivot axle 30 is moved to the released position, the pivot axle 30 is away from the inner end 22 of the latch 20, whereby the latch 20 is allowed to freely slide in the latch hole 12;

a drawer buckle 90, connecting to the driving assembly 40 and exposing on the outer side of the casing 10 and the front board 101 for being held or gripped to drive the motion of the driving assembly 40;

a fixed piece 103 disposed on the main body 100 for producing a position limiting effect against the bevel end 21 of the latch 20 when the pivot axle 30 is at the fixed position, wherein the driving assembly 40 comprises:
a hollow barrel 41, fixed in the space 11, wherein the hollow barrel 41 is combined with the casing 10 by at least one screw member 18 inserted thereon with at least a part of the screw member 18 exposing on the surface of the casing 10, while at least one flexible part 42 is disposed on a side wall of the hollow barrel 41, with a hook 43 protruding from the inner side of the flexible part 42, and a spring member 44 disposed between the flexible part 42 and the casing 10;

a tube body 50, rotatably disposed in the hollow barrel 41, with one end thereof provided with an axle hole 51 for receiving an end of the pivot axle 30, and the other end provided with a contact hole 52 for the drawer buckle 90 to be connected with by at least one method selected from the group consisting of screwing, fixing, adhering, and welding, while a pillow block 53 is disposed between the drawer buckle 90 and the tube body 50 for adjusting the gap distance in between. Therein, at least one guiding notch 54 for coupling the hook 43 is concavely disposed on the peripheral surface of the tube body 50, whereby when the drawer buckle 90 drives the tube body 50 to rotate, the hook 43 is allowed to move along the outline of the guiding notch 54 and thus drives the tube body 50 and the pivot axle 30 to move together freely between the locked position and the released position.

Therein, the guiding notch 54 comprises a hooked section 541, a free section 542 axially disposed in alignment with the hooked section 541 and in parallel against the tube body 50, and a sliding section 543 connecting with at least one common lateral side of the hooked section 541 and the free section 542, while the free section 542 is on the side adjacent to the latch 20. In a preferred embodiment, two sides of both the hooked section 541 and the free section 542 are provided with a sliding section 543, respectively, and the hooked section 541 is defined by two bevels forming a gorge in the middle of the hooked section 541 and gradually raising toward the sliding sections 543 on the lateral side, while the sliding section 543 is mainly disposed in parallel against the tube body 50. Further, a blocking section 544 is provided between the free section 542 and the locked section 541, wherein the blocking section 544 includes a sliding bevel 545 disposed on the free section 542 and a blocking surface 546 disposed on the locked section 541.

Moreover, a pivot seat 15 is axially provided in the space 11 along the casing 10 for the axle hole 51 of the tube body 50 to mount around; also, the pivot seat 15 is passed through by a pivot hole 16, which connects with the space 11 and the latch hole 12 for the pivot axle 30 to insert through the latch hole 12. Therein, the axle hole 51 comprises a first section 511 and a second section 512, and the diameter of the first section 511 is larger than the diameter of the second section 512, wherein the first section 511 is allowed to receive the pivot seat 15, and the second section 512 is allowed to receive the end of the pivot axle 30.

Therein, the tube body 50 is allowed to be made of a flexible plastic material, and the pivot axle 30 is made of a metal or alloy material. Thereby, the end of the pivot axle 30 is allowed to be fittingly fixed in the second section 512, and the weight of the tube body 50 is decreased. Also, the pivot axle 30 at the locked position exerts strength which is enough to interfere in the downward motion of the latch 20 when the drawer is coerced to be opened, thereby preventing intentional damage. In addition, an axial resilient member 17 mounts around the pivot axle 30 and is positioned between the pivot seat 15 and the axle hole 51, whereby the tube body 50 is permanently pushed toward the drawer buckle 90.

Further, at least one protective recess 45 is disposed on a side wall of the hollow barrel 41, while at least one protective block 55 capable of sliding in the protective recess 45 protrudes on the peripheral surface of the tube body 50. Also, the protective recess 45 comprises a parallel section 451 and a taper section 452.

While detail structures are understood, the acting method of the present invention is explained hereinafter.

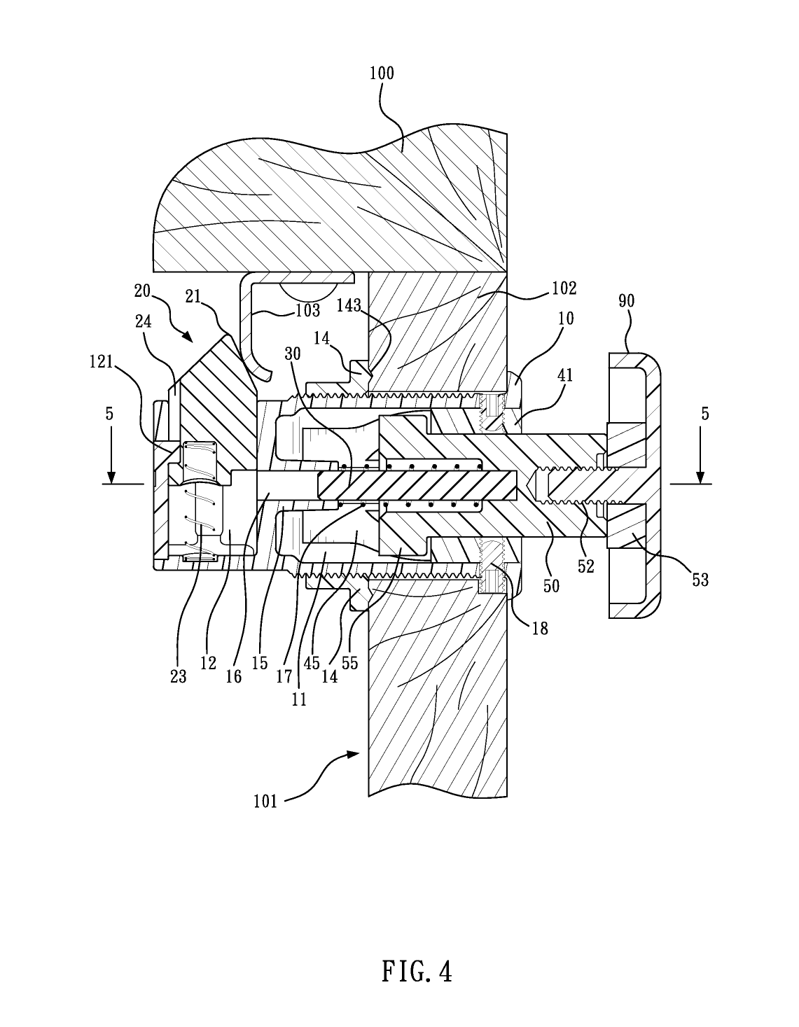

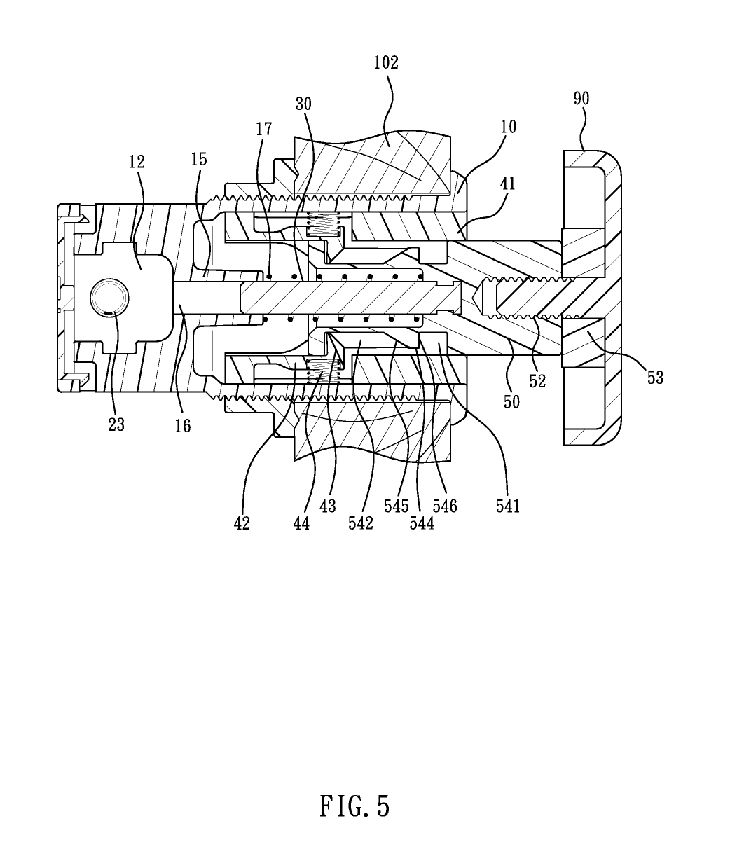

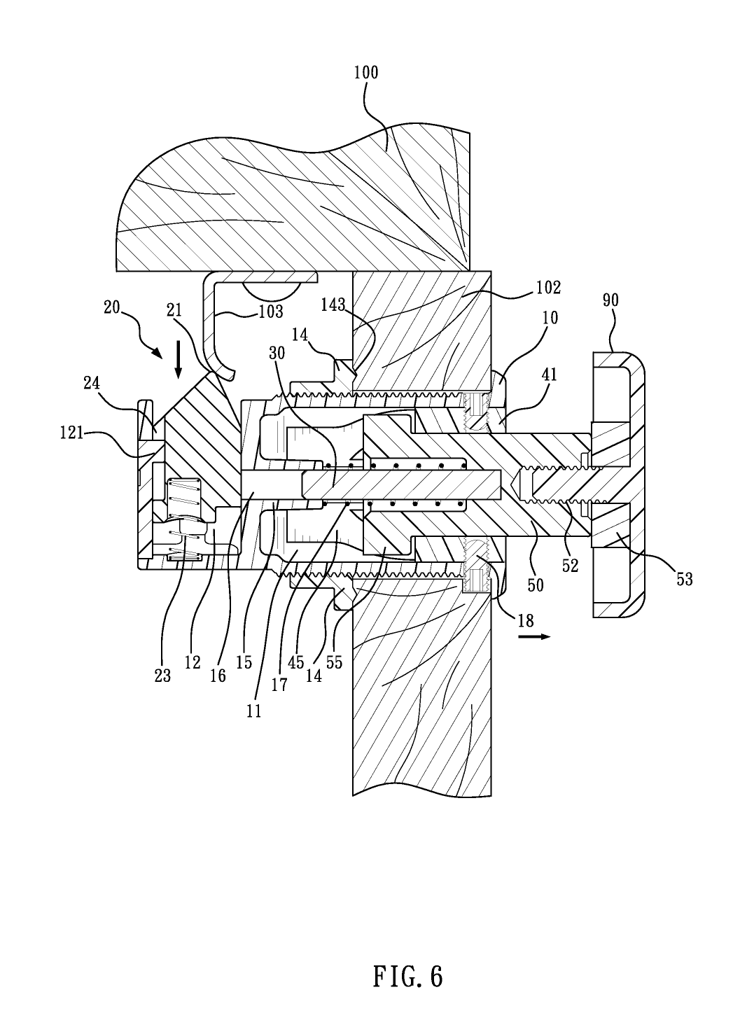

Referring to FIG. 4 and FIG. 5, when the pivot axle 30 is at the released position, the inner end 22 of the latch 20 is away from the pivot axle 30, and the hook 43 is positioned in the free section 542, whereby the latch 20 is allowed to stick upward or be pushed downward in the latch hole 12. As shown in FIG. 6, when the user pulls the drawer buckle 90, the latch 20 is pushed down by the fixed piece 103 along the bevel of the bevel end 21 and thus forced into the latch hole 12, whereby the drawer 101 is allowed to be pulled out. On the other hand, when the drawer 101 is pushed inward, the latch 20 is also pushed down into the latch hole 12, whereby the drawer 101 is restored to a close status. Further, the radial resilient member 23 provides a bouncing force to keep the latch 20 to permanently stick upward, whereby a slight fixing force is still provided even when the pivot axle 30 is at the released position. Therefore, the drawer 101 is prevented from sliding open due to tilting or shaking conditions, especially on transportations such as ships or aircrafts.

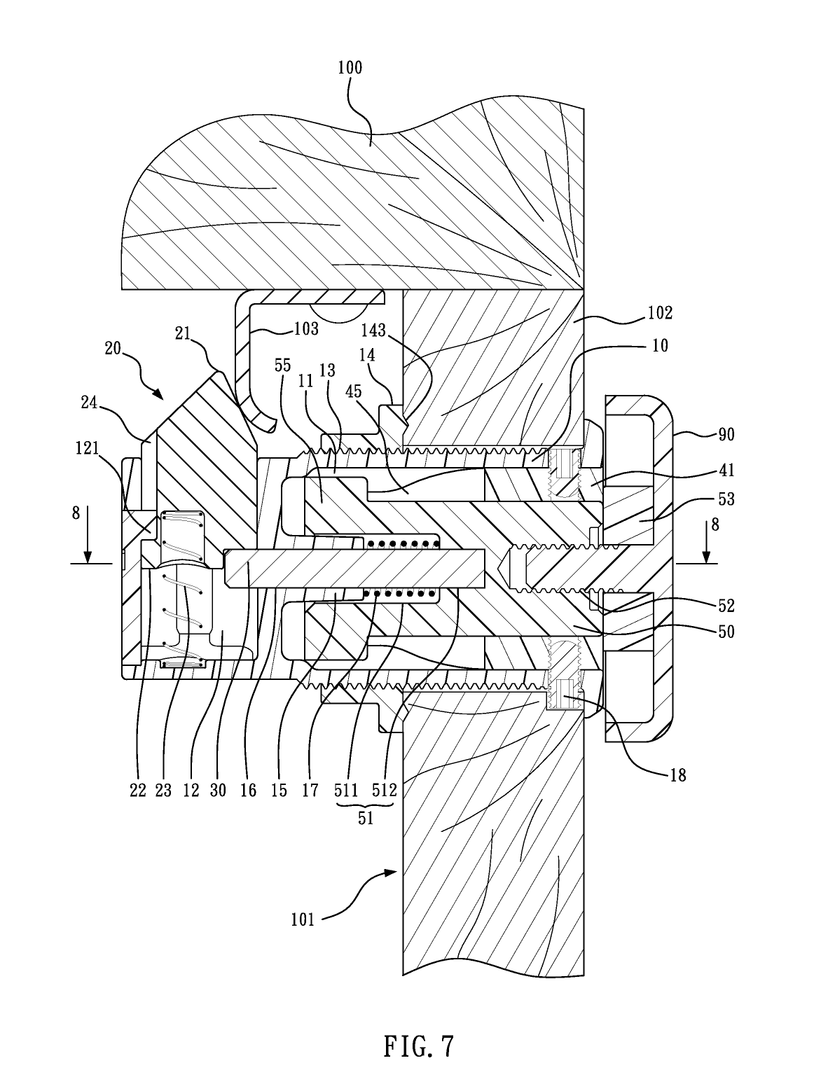

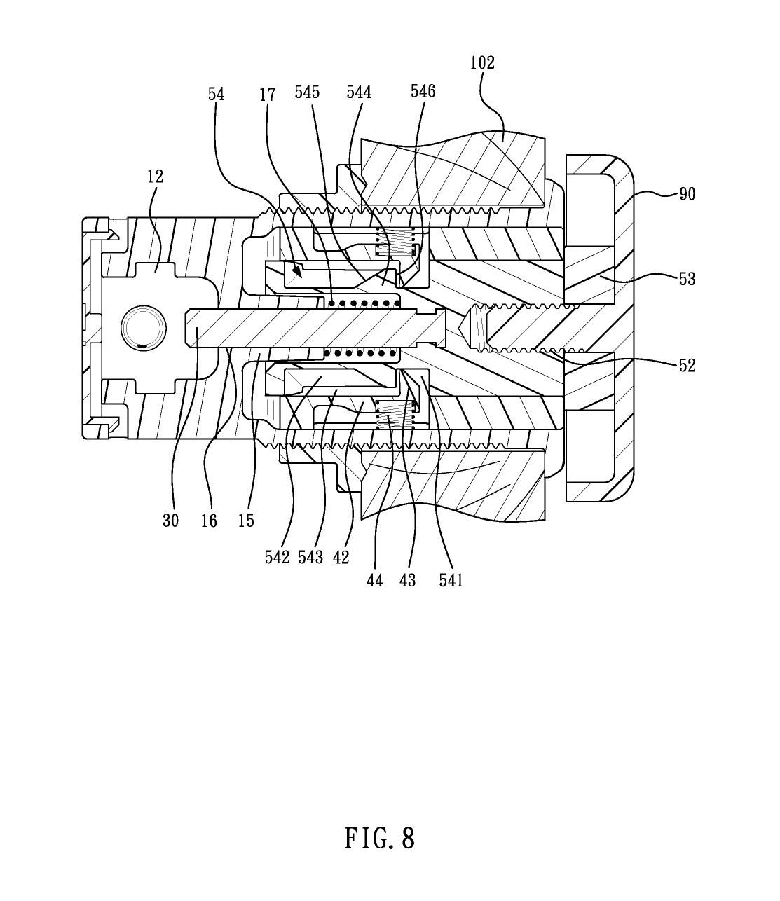

Referring to FIG. 7 and FIG. 8, when the user wants to lock the drawer 101, the user needs only to push the drawer buckle 90 inward after closing the drawer. Thereby, the tube body 50 and the guiding notch 54 axially move inward, and the hook 43 previously positioned in the free section 542 slides along the sliding bevel 545 of the blocking section 544 and further trips to the hooked section 541; also, the pivot axle 30 is driven by the tube body 50 to slide toward the latch 20, whereby at least a part of the pivot axle 30 moves inward to contact the inner end 22 of the latch 20 and prevents the latch 20 from being pushed downward into the latch hole 12; thus, the pivot axle 30 is switched from the released position to the locked position. Thereby, a positional fixing effect is produced between the latch 20 and the fixed piece 103, stably fixing the drawer 101 inside the main body 100. Furthermore, when the hook 43 trips to the locked section 541 through the sliding bevel 545, the blocking surface 546 of the locked section 541 efficiently prevents the hook 43 from tripping back to the free section 542, so that the drawer 101 is unable to be open even if the drawer buckle 90 is pulled outward, thereby assuring the lock-up effect.

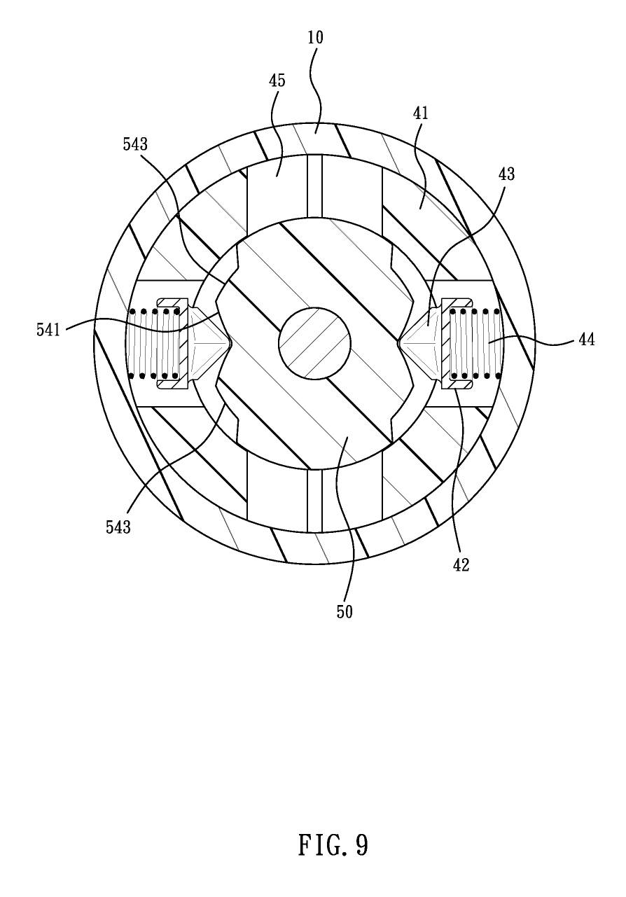

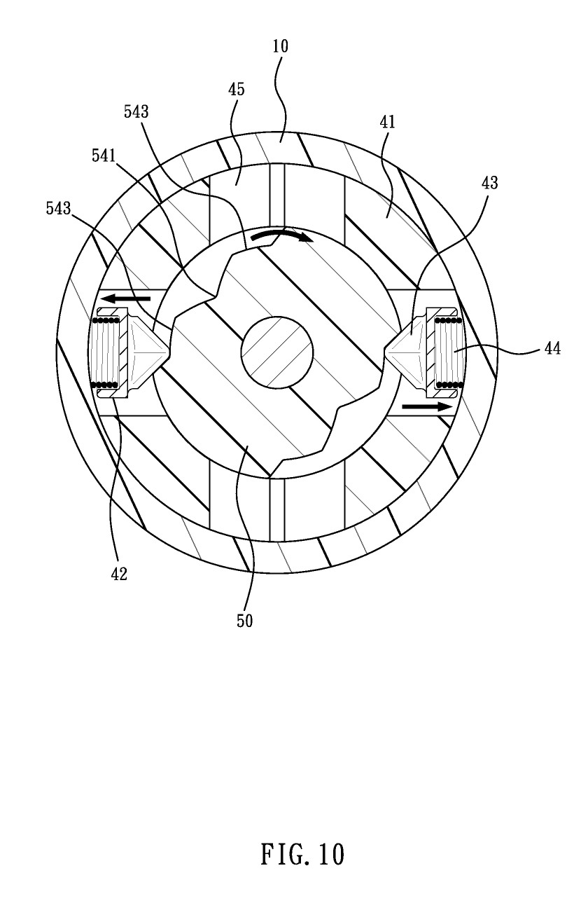

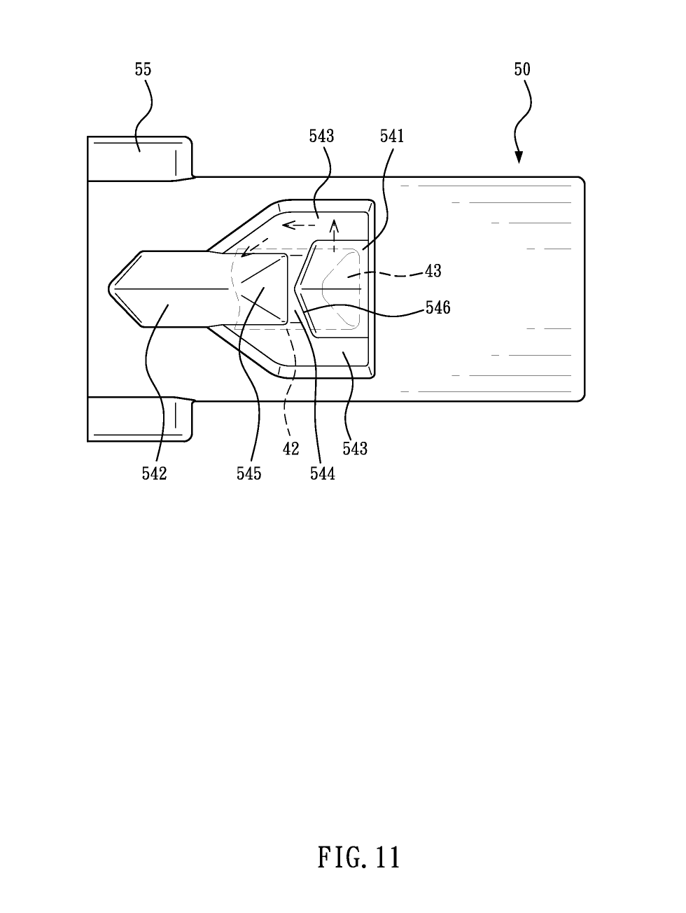

As shown in FIG. 9, when the user wants to open the locked drawer, the user needs only to rotate the drawer buckle 90, whereby the tube body 50 and the guiding notch 54 rotate in the hollow barrel 41 and trigger the following procedure. First, the hook 43 moves from the locked section 541 to the sliding section 543 due to the rotation of the tube body 50 (as shown in FIG. 10). Next, the axial resilient member 17 pushes the tube body 50 toward the drawer buckle 90, causing the tube body 50 to slide outward. Finally, the hook 43 slides along the sliding section 543 and further trips back to the free section 542 (as shown in FIG. 11 and FIG. 4). Through the procedure above, only a simple rotation of the drawer buckle 90 is needed to drive the pivot axle 30 to rotate in accordance with the tube body 50, thereby withdrawing the end of the pivot axle 30 outward and recovering the latch 20 to a free-sliding status, switching the pivot axle 30 from the locked position to the released position. In the preferred embodiment, both lateral sides of the locked section 541 and the free section 542 are provided with a sliding section 543, respectively; as a result, the unlocking procedure is allowed to be accomplished while the user rotates the drawer buckle 90 either clockwise or counter-clockwise

The protective recess 45 and the protective block 55 further provide an over-travel protection. During the operation, edges of the protective recess 45 and the protective block 55 produce a limitation to the maximum displacement of such moving mechanism for preventing the flexible part 42 and the hook 43 from detaching from the guiding notch 54 or damaged.

In addition, common drawer buckles 90 in the market are mostly provided with a threaded rod or rod member alike for being installed on the drawer 101. With regard to the present invention, one end of the tube body 50 connecting to the drawer buckle 90 is provided with a contact hole 52 for currently existing drawer buckles 90 in the market to be connected with by at least one method selected from the group consisting of screwing, fixing, adhering, and welding. Therefore, the present invention is able to be applied with currently existing drawer buckles and be installed onto cabinets or tables with different styles, thereby preventing normal usages or appearances from being negatively affected by different designs, thus increasing added value of the present invention. Also, a pillow block 53 is provided between the drawer buckle 90 and the tube body 50 for adjusting the gap distance in between; in other words, when the size of the drawer buckle 90 varies, the pillow block 53 of different sizes are allowed to be adopted for adjusting the drawer buckle 90 to a position suitable for being held or gripped by users.

With the detailed explanation above, skilled people in the field of the present invention are able to understand that the present invention obviously differs from prior arts and thus possesses inventive steps. Also, the present invention is able to accomplish the effects that are not achievable by prior arts. Therefore, the present invention is patentable.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A drawer knob latch installed on a drawer capable of sliding inwardly or outwardly on a main body comprising:
a casing, provided with a hollow space therein, and inserted on a front board of a drawer, wherein one end of the casing protruding inwardly from the front board is peripherally radially provided with a latch hole;
a latch, comprising a bevel end and an inner end which is slidingly disposed in the latch hole;
a pivot axle, slidingly moveably disposed in the space along a central axis of the casing, and driven by a driving assembly in the space, thus capable of moving toward or away from the latch, thereby moving between a locked position and a released position; and
a drawer buckle, connecting to the driving assembly and exposing on the outer side of the casing and the front board for being held or gripped to drive the motion of the driving assembly.

2. The drawer latch of claim 1, wherein at least a part of the pivot axle is located between the casing and the inner end of the latch when the pivot axle is moved to the locked position, whereby the latch is not allowed to be pushed down into the latch hole, and the pivot axle is away from the inner end of the latch when the pivot axle is moved to the released position, whereby the latch is allowed to be pushed down into the latch hole.

3. The drawer latch of claim 2, wherein the driving assembly further comprises:
a hollow barrel, fixed in the space, and at least one flexible part disposed on a side wall of the hollow barrel, with a hook protruding from the inner side of the flexible part;
a tube body, rotatably disposed in the hollow barrel, with one end thereof provided with an axle hole for receiving an end of the pivot axle and the other end connecting to the drawer buckle, wherein at least one guiding notch is concavely disposed on the peripheral surface of the tube body for coupling the hook, thereby driving the tube body and the pivot axle to move together freely between the locked position and the released position along the outline of the guiding notch when the drawer buckle drives the tube body to move.

4. The drawer latch of claim 3, wherein the guiding notch comprises a hooked section, a free section axially disposed in alignment with the hooked section and in parallel against the tube body, and a sliding section connecting with at least one common lateral side of the hooked section and the free section.

5. The drawer latch of claim 4, wherein two sides of both the hooked section and the free section are provided with a sliding section, respectively, and the hooked section is defined by two bevels forming a gorge in the middle of the hooked section and gradually raising toward the sliding sections on the lateral side

6. The drawer latch of claim 4, wherein a blocking section is provided between the free section and the locked section, while the blocking section includes a sliding bevel disposed on the free section and a blocking surface disposed on the locked section.

7. The drawer latch of claim 3, wherein a pivot seat is axially provided in the space along the casing 10 for the axle hole of the tube body to be mounting around, while the pivot seat is passed through by a pivot hole, which connects with the space and the latch hole for the pivot axle to insert through the latch hole.

8. The drawer latch of claim 7, wherein the axle hole comprises a first section and a second section, the diameter of the first section larger than the diameter of the second section, the first section allowed to receive the pivot seat, and the second section allowed to receive the end of the pivot axle, while an axial resilient member mounts around the pivot axle and is positioned between the pivot seat and the axle hole.

9. The drawer knob latch of claim 3, wherein at least a protective recess is disposed on a side wall of the hollow barrel, and at least a protective block capable of sliding in the protective recess protrudes on the peripheral surface of the tube body, while the protective recess comprises a parallel section and a taper section.

10. The drawer knob latch of claim 3, wherein one end of the tube body connecting to the drawer buckle is provided with a contact hole for the drawer buckle to be connected with by at least one method selected from the group consisting of screwing, fixing, adhering, and welding.

11. The drawer knob latch of claim 3, wherein a spring member is disposed between the flexible part and the casing.

12. The drawer knob latch of claim 3, wherein the hollow barrel is combined with the casing by at least one screw member inserted thereon.

13. The drawer knob latch of claim 12, wherein at least a part of the screw member is exposing on the surface of the casing.

14. The drawer knob latch of claim 1, wherein a threaded section is disposed on the peripheral surface of the casing for a ring part to be screwed on.

15. The drawer knob latch of claim 14, wherein the ring part is provided with an angled part and a protrusive edge having plural convex points thereon.

16. The drawer knob latch of claim 1, wherein a fixed piece is disposed on the main body for producing a position limiting effect against the bevel end of the latch when the pivot axle is at the fixed position.

17. The drawer knob latch of claim 1, wherein a positioning groove is concavely disposed on the latch, and a limiter capable of sliding in the positioning groove is convexly disposed in the latch hole for limiting the sliding movement of the latch in the latch hole.

18. The drawer knob latch of claim 1, wherein a radial resilient member is provided between the casing and the inner end of the latch.
